(19) United States
(12) Patent Application Publication
(10) Pub. No.: US 2009/0221302 A1
(43) Pub. Date: Sep. 3, 2009

(54) METHOD, APPARATUS AND COMPUTER PROGRAM FOR REVERSE LOAD BALANCING FOR THE PROVISION OF SERVICES TO CLIENT DEVICES

(76) Inventors: Vesa Pekka Luiro, Kempele (FI); Quinn Jacobson, Sunnyvale, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/039,477

(22) Filed: Feb. 28, 2008

(51) Int. Cl. H04Q 7/20; H04M 1/00

(52) U.S. Cl. 455/456.6; 455/422.1; 455/550.1

(57) ABSTRACT

An apparatus for providing reverse load balancing for the provision of services to client devices may include a processor. The processor may be configured to receive, at a device, a report from each of a plurality of mobile terminals, each report including a dynamic value indicative of a characteristic of the respective mobile terminal, define a group of mobile terminals based on members of the group having respective dynamic values similar to each other within a threshold amount, and provide the members of the group with rules defining criteria for at least some of the members with respect to providing future reports to the device.

### FIELD OF THE INVENTION

Embodiments of the present invention relate generally to the provision of services to mobile platforms and, more particularly, relate to an apparatus, method and a computer program product for providing services to client devices such as mobile terminals with reverse load balancing.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Such increased ease of information transfer and convenience to users has recently been accompanied by an increased ability to provide mobile communications at a relatively low cost. Accordingly, mobile communication devices are becoming ubiquitous in the modern world. With the rapid expansion of mobile communications technology, there has been a related rapid expansion in those services that are demanded and provided via mobile communication devices.

One area in which services have recently expanded relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc, or even from a combination of the mobile terminal and the network device. In this regard, various applications and software have been developed and continue to be developed in order to give the users robust capabilities to perform tasks, communicate, obtain information or services, entertain themselves, etc. in either fixed or mobile environments.

One example of information and services that may desirably be obtained in a mobile environment relates to traffic information and services. In this regard, for example, individuals in route to a location or planning to embark toward the location may be interested in obtaining information related to traffic density, accident information, detours or traffic advisories, weather or road conditions, navigation services or other traffic related services. While there are currently a number of fixed sensor networks for monitoring traffic, such networks are often expensive to implement and maintain.

Meanwhile, in cellular networks like GSM, WCDMA, etc., it is typically possible to determine the geographic location of the mobile terminals, and provide location-based or location-aware services based upon the location of the mobile terminals. Furthermore, given the ubiquitous nature of mobile terminals, it may be possible to employ mobile terminals in providing information to traffic services. However, mobile terminals are typically battery operated and have limited resources. Thus, since providing location related information in a manner that may be useful for most traffic services typically requires frequent exchanges of information, it may be difficult to provide efficient traffic monitoring without negatively impacting mobile terminal and/or network performance in areas such as power consumption, data transfer cost, user experience, etc.

Accordingly, it may be desirable to develop a mechanism by which mobile terminals may be employed for the provision of traffic monitoring services that may overcome at least some of the disadvantages described above.

### BRIEF SUMMARY OF THE INVENTION

A method, apparatus and computer program product are therefore provided that may enable reverse load balancing with respect to the provision of services to mobile terminals. In this regard, load balancing is typically thought of in the context of balancing the load on a bank of servers by managing requests (which may be received, for example, from mobile terminals or personal computers) directed to the servers from client devices. Such load balancing may improve server performance by optimizing or otherwise improving resource utilization, throughput, and/or response time of the server bank. Accordingly, reverse load balancing may be considered as a balancing of processing or resource consumption at the client side instead of at the server side. In the context of traffic information and services, which is one example of an application of embodiments of the present invention, such reverse load balancing may minimize the communication requirements of individual client devices or mobile terminals, while maintaining sufficient data for the serving devices to obtain needed information to process data and provide a corresponding service based on the processed data. In this regard, reverse load balancing may enable similarly situated mobile terminals to be organized into groups in which communication from the individual members of the group may be managed to decrease the communication requirements of the members of the group, while maintaining overall service quality. Accordingly, services such as traffic services and other traffic information may be provided in an efficient manner as compared to conventional mechanisms.

In one exemplary embodiment, a method of providing reverse load balancing for the provision of services to client devices is provided. The method may include receiving, at a device, a report from each of a plurality of mobile terminals, each report including a dynamic value indicative of a characteristic of the respective mobile terminal, defining a group of mobile terminals based on members of the group having respective dynamic values similar to each other within a threshold amount, and providing the members of the group with rules defining criteria for at least some of the members with respect to providing future reports to the device.

In another exemplary embodiment, a computer program product for providing reverse load balancing for the provision of services to client devices is provided. The computer program product may include at least one computer-readable storage medium having computer-readable program code portions stored therein. The computer-readable program code portions may include a first executable portion, a second executable portion and a third executable portion. The first executable portion may be for receiving, at a device, a report from each of a plurality of mobile terminals, each report including a dynamic value indicative of a characteristic of the respective mobile terminal. The second executable portion may be for defining a group of mobile terminals based on members of the group having respective dynamic values similar to each other within a threshold amount. The third executable portion may be for providing the members of the group with rules defining criteria for at least some of the members with respect to providing future reports to the device.

In another exemplary embodiment, an apparatus for providing reverse load balancing for the provision of services to client devices is provided. The apparatus may include a processor. The processor may be configured to receive, at a device, a report from each of a plurality of mobile terminals, each report including a dynamic value indicative of a characteristic of the respective mobile terminal, define a group of mobile terminals based on members of the group having respective dynamic values similar to each other within a threshold amount, and provide the members of the group with rules defining criteria for at least some of the members with respect to providing future reports to the device.

In another exemplary embodiment, an apparatus for providing reverse load balancing for the provision of services to client devices is provided. The apparatus includes means for receiving, at a device, a report from each of a plurality of mobile terminals, each report including a dynamic value indicative of a characteristic of the respective mobile terminal, means for defining a group of mobile terminals based on members of the group having respective dynamic values similar to each other within a threshold amount, and means for providing the members of the group with rules defining criteria for at least some of the members with respect to providing future reports to the device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram showing an apparatus for providing reverse load balancing for the provision of services to client devices according to an exemplary embodiment of the present invention;

FIG. 4 illustrates an example of a plurality of cars from which reports may be received according to an exemplary embodiment of the present invention;

FIG. 5 shows a cell defined according to an exemplary embodiment of the present invention;

FIG. 6 illustrates the provision of rules to various different members of the group;

FIG. 7 illustrates an example of a mapping of reports received from mobile terminals within a group according to an exemplary embodiment of the present invention;

FIG. 8 illustrates an example of a map view providing traffic report information according to an exemplary embodiment of the present invention; and

FIG. 9 is a flowchart according to an exemplary method of providing reverse load balancing for the provision of services to client devices according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

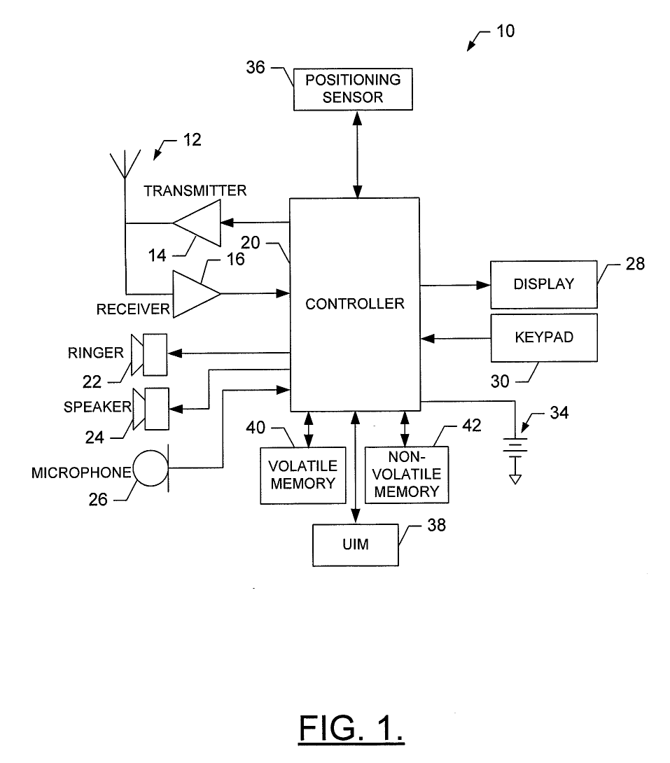

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

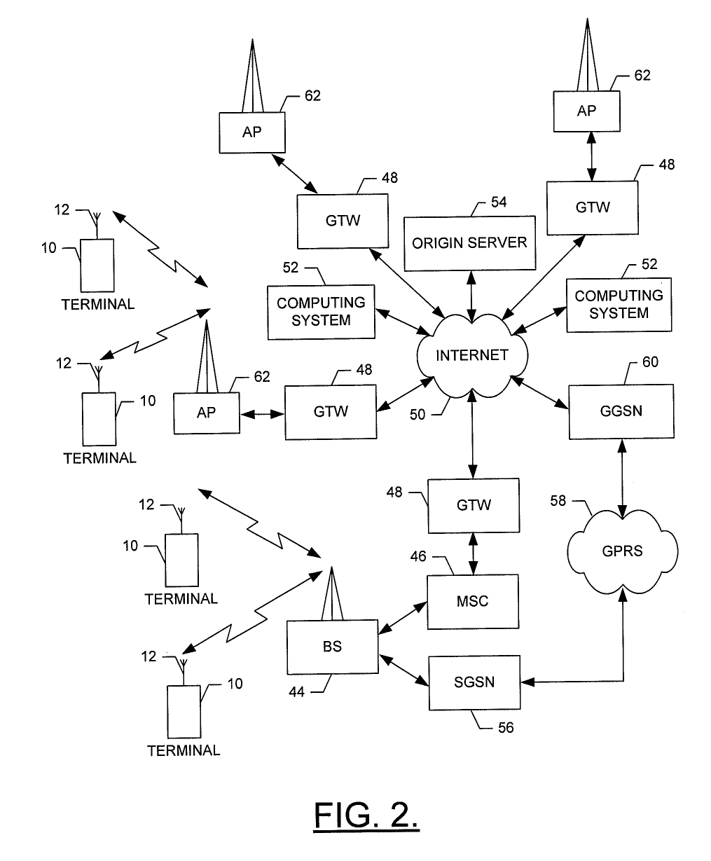

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In addition, the mobile terminal 10 may include a positioning sensor 36. The positioning sensor 36 may include, for example, a global positioning system (GPS) sensor, an assisted global positioning system (Assisted-GPS) sensor, a Bluetooth (BT)-GPS mouse, other GPS or positioning receivers or the like. However, in one exemplary embodiment, the positioning sensor 36 may include a pedometer or inertial sensor. In this regard, the positioning sensor 36 may be capable of determining a location of the mobile terminal 10, such as, for example, longitudinal and latitudinal directions of the mobile terminal 10, or a position relative to a reference point such as a destination or start point.

Information from the positioning sensor 36 may include or otherwise be used to derive further information related to the position of the mobile terminal 10. For example, such information may include or be used to determine speed and/or acceleration of the mobile terminal 10 (and therefore also of any vehicle in which the mobile terminal 10 is being transported).

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content or information sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a server, personal computer or other device, absent any communication with the system of FIG. 2.

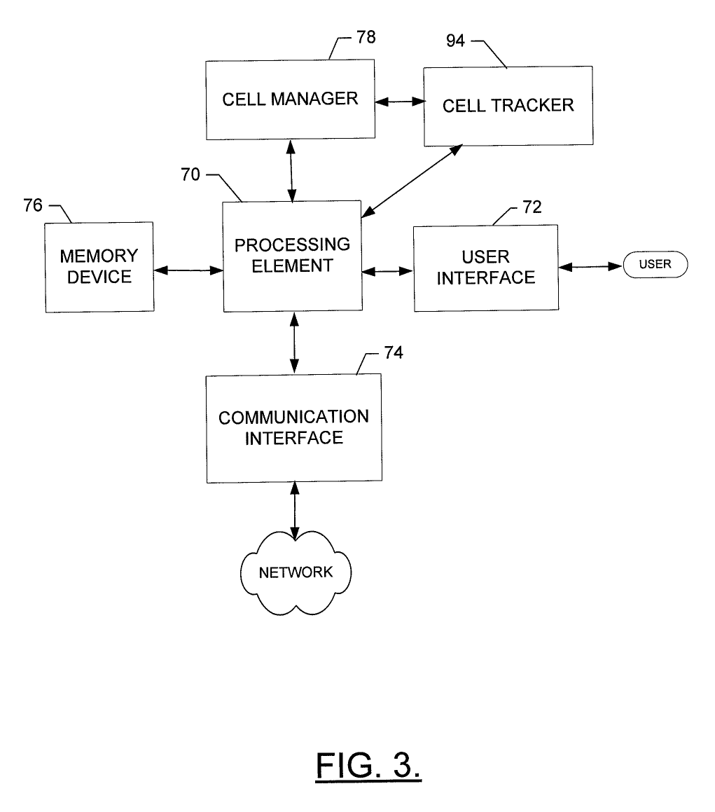

An exemplary embodiment of the invention will now be described with reference to FIG. 3, in which certain elements of an apparatus for enabling reverse load balancing with respect to the provision of services to mobile terminals are displayed. The apparatus of FIG. 3 may be embodied as or otherwise employed, for example, on a network device such as a server of FIG. 2. However, it should be noted that the system of FIG. 3, may also be employed on a variety of other devices, both mobile (e.g., the mobile terminal 10) and fixed, and therefore, the present invention should not be limited to application on devices such as servers. It should also be noted that while FIG. 3 illustrates one example of a configuration of an apparatus for enabling reverse load balancing with respect to the provision of services to mobile terminals, numerous other configurations may also be used to implement embodiments of the present invention.

Referring now to FIG. 3, an apparatus for enabling reverse load balancing with respect to the provision of services to mobile terminals is provided. The apparatus may include or otherwise be in communication with a processing element 70, a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be one of a plurality of databases that store information in the form of static and/or dynamic information, for example, in association with a particular location, event or service point.

The processing element 70 may be embodied in a number of different ways. For example, the processing element 70 may be embodied as a processor, a coprocessor, a controller or various other processing means or devices including integrated circuits such as, for example, an ASIC (application specific integrated circuit) or FPGA (field programmable gate array). In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network.

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server, the user interface 72 may be limited, or even eliminated.

In an exemplary embodiment, the processing element 70 may be embodied as or otherwise control a cell manager 78. The cell manager 78 may be any means or device embodied in hardware, software, or a combination of hardware and software that is configured to carry out the functions of the cell manager 78 as described herein. In this regard, for example, the cell manager 78 (which in an exemplary embodiment may be embodied at a server or other network device) may be configured to receive information from a plurality of mobile terminals and organize the mobile terminals (e.g., and their respective vehicles) into groups based on characteristics of the terminals as provided in the received information. As such, for example, the cell manager 78 may be configured to define initial cells corresponding to the defined groups including defining the structure of such cells, the number of terminals or vehicles in a group, variation limits that are acceptable within each group (e.g., speed variation limits), etc. The information received may be indicative of one or more dynamic values that may be indicative of one or more respective characteristics of the mobile terminal providing the information. More specifically, by way of example, the received information may include a report or series of reports providing dynamic information about the location of the mobile terminal, a speed at which the mobile terminal is traveling, direction of motion, other information determinable from position reports (e.g., GPS positioning messages) and/or other information related to conditions sensed or experienced at a location of the mobile terminal (e.g., weather conditions, accident information, detours, road conditions, etc.).

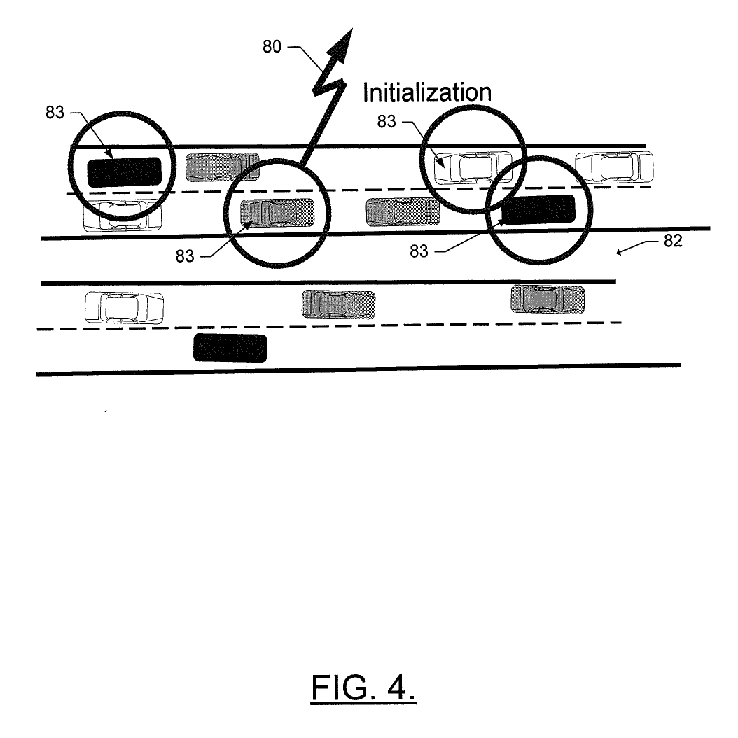

FIG. 4 illustrates an example of a plurality of cars or vehicles from which reports may be received according to an exemplary embodiment of the present invention. As such, at least some of the vehicles of FIG. 4 should be assumed to include or otherwise have a mobile terminal capable of making reports associated therewith. Although FIG. 4 only shows one vehicle currently making a report 80, it may be assumed that the other vehicles that are circled in FIG. 4 are also capable of communication with the cell manager 78 (e.g., via a respective mobile terminal) to provide reports at various intervals. Thus, the circled vehicles may define a group 83 of mobile terminals. Vehicles that are not circled may be vehicles that are not registered to a traffic information provision service according to an exemplary embodiment, or otherwise do not actively participate with reporting (e.g., such vehicles may not have mobile terminals associated therewith). As shown in FIG. 4, which shows two way traffic separated by a median 82, vehicles on one side of the median 82 may be headed in one direction, while vehicles on the other side of the median 82 may be headed in an opposite direction.

Reports may be made in any suitable protocol or format. In an exemplary embodiment, reports may be made via extensible markup language (XML) messages. An exemplary message sent from a mobile terminal to the apparatus of FIG. 3 may be as illustrated below:

```
<!-handshake for establishing traffic reporting -->
<?xml version=”1.0” encoding=”ISO-8859-1”?>
<traffic>
  <service>http://123.456.789.1 </service>
  <IMEI>123456789012345</IMEI>
  <time>15:38:52, 25/12/2008</time>
  <status>active</status>
  <traffic_data>
    <location>64.945165, 25.438555</location>
    <direction>23</direction>
    <speed>62, kph</speed>
  </traffic_data>
</traffic>
```

As indicated above, the cell manager 78, which may receive the information (e.g., the reports 80) over a network via the communication interface 74 from one or more mobile terminals, may utilize the information to define groups of mobile terminals as belonging to a particular cell. The information received in the reports 80 may be considered metadata. As such, devices with mutually common or similar metadata may be grouped together and the respective group may be used to define a corresponding cell. Each cell may be defined as a moving or dynamic cell of mobile terminals including the members of the defined group. The cell may be defined by grouping mobile terminals based on members of the group having respective dynamic values similar to each other within a threshold amount. For example, the cell may be defined by forming a group including all mobile terminals in a particular geographical region or area or within a specified distance of a particular location. As such, the received information or reports may indicate where each one of a plurality of mobile terminals is located. The cell manager 78 may utilize this information to group mobile terminals that are relatively close to each other (e.g., within a predefined distance of one another) into a group and define a respective cell. As an alternative, the cell manager 78 may include information defining a particular road, series of roads, or geographical area into a series of segments or sub-areas. Each of the segments may define a cell. Thus, at any given time during which cell formation occurs, the mobile terminals located within each respective segment may be grouped together with other mobile terminals in the same segment to form a cell with the other mobile terminals. The cell manager 78 may then project movement of the cell based on the received information from the members of the group. For example, the cell may move along the road/roads at a speed corresponding to the speed (e.g., average speed) of the members as provided by further reports received from the respective members.

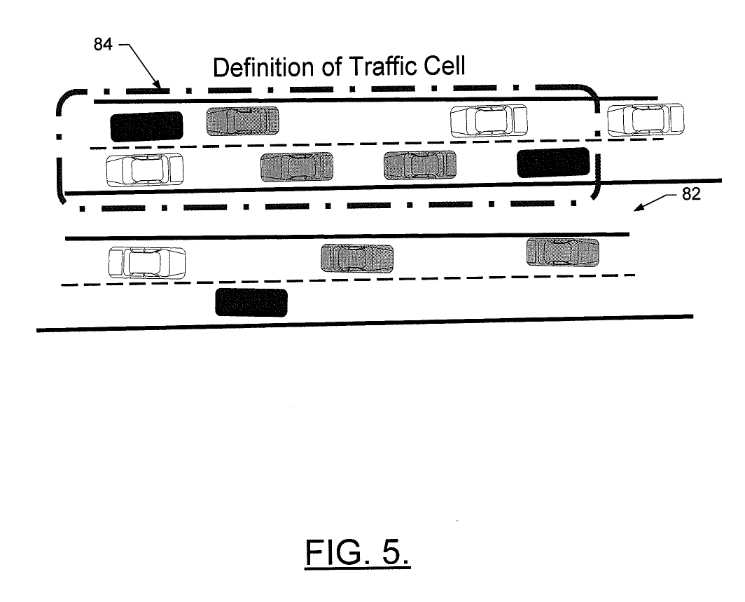

FIG. 5 shows a cell 84 defined according to an exemplary embodiment of the present invention. As shown in FIG. 5, the cell 84 typically only includes vehicles traveling in a common direction. Accordingly, the cell manager 84 may also utilize information related to direction of motion to define cells within a particular geographic region into one cell headed in one direction and another cell headed in the opposite direction. However, adjacent cells headed in either the same or opposite directions need not correspond to each other in size (geographic or in terms of membership) or shape. As shown in FIG. 5, the cell 84 may include vehicles that do not necessarily communicate with the apparatus of FIG. 3. In this regard, although the group includes only those vehicles that are in communication with the apparatus of FIG. 3, the cell 84, which may be defined in terms of a moving boundary originally associated with a geographic area, may have within it also vehicles that are not members of the group 83.

As indicated above, some embodiments may be utilized for providing a traffic reporting service. However, a traffic reporting service typically provides information that may be highly dynamic in nature. Accordingly, an accurate representation of traffic information may typically require the provision of information to a server providing the service at a relatively high frequency rate. As such, the service may typically inquire of mobile terminals or otherwise receive numerous reports from mobile terminals at high rates of occurrence, which could increase resource consumption and decrease mobile terminal battery life. However, embodiments of the present invention may define the groups of mobile terminals that may be likely to experience similar conditions into a single cell. The cell may then be considered in the aggregate and reports from the members of the group of mobile terminals in the cell may be reduced for any particular member in the cell by spreading reporting responsibilities over the membership of the group. In other words, since reports received from any single member of the group may be considered to be representative of conditions likely to also be experienced by other members of the group, responsibilities for reporting information may be distributed amongst the members of the group in a manner that reduces the frequency at which any one member must make such reports. For example, if a typical reporting rate for a traffic service requires a traffic report on a six reports per minute rate, a group of six mobile terminals could each be responsible for only one report each minute. However, any desirable division of reporting could be provided.

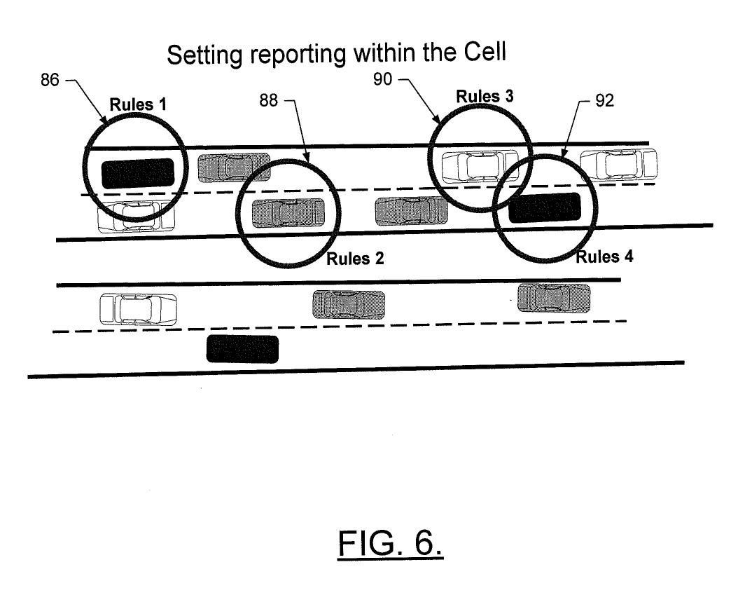

In this regard, the cell manager 78 may also be configured to provide the members of the group with rules defining criteria for each of the members with respect to providing future reports. In other words, each member of the group within the cell may be provided with its own particular set of rules for reporting further information to the apparatus of FIG. 3. However, each set of rules could be identical or different. As such, for example, FIG. 6 illustrates the provision of rules to various different members of the group. In this regard, for example, a first set of rules 86 may be provided to a first member of the group, a second set of rules 88 may be provided to a second member of the group, a third set of rules 90 may be provided to a third member of the group, and a fourth set of rules 92 may be provided to a fourth member of the group.

In some embodiments, the rules provided by the cell manager 78 may include or otherwise define a report rotation. Each of the members of the group may receive rules including its own respective report rotation. As an alternative, the rules provided to each member may include the report rotation for each other member or at least one other member as well. The report rotation may be defined such that only a predetermined fraction of the members provide reports at any given time at which a report is to be received. In some embodiments, the cell manager 78 may provide the members of the group with rules defining, for at least one of the members, a condition, the detection of which triggers the at least one member to provide a report to the device. As such, for example, if a vehicle experiences a speed increase or decrease above a certain level, the vehicle (or its mobile terminal) may make a report indicative of the change in conditions. Event triggered reporting may be made in addition to or instead of cyclic reporting. Furthermore, the cell manager 78 may issue rule changes at any time such as in response to membership changes in the group, location changes, traffic condition changes, etc. In some embodiments, changes in conditions that may result in a report being issued (e.g., outside a normally scheduled report) may include windshield wiper activation or other such events that may be indicative of changes in traffic and/or weather conditions.

Messaging providing rules to the terminals or vehicles may be made in any suitable protocol or format. In an exemplary embodiment, such messages may be made via XML messages. An exemplary message sent from the apparatus of FIG. 3 to a mobile terminal may be as illustrated below:

```
<!-instructions for how to report traffic data to the service -->
<?xml version=”1.0” encoding=”ISO-8859-1”?>
<traffic>
<IMEI>123456789012345</IMEI>
<service>http://123.456.789.1:12345</service>
  <schedule>
    <send_next>15:39:10, 25/12/2008</send_next>
    <time_interval>00:00:20</time_interval>
  </schedule>
  <parameters>
    < >
    < >
  </parameters>
</traffic>
```

In an exemplary embodiment, the parameters may provide triggers for reporting such as event, frequency and/or time based triggers.

In an exemplary embodiment, the processing element 70 may also be embodied as or otherwise control a cell tracker 94. The cell tracker 94 may be any device or means embodied in software, hardware or a combination of hardware and software that is configured to perform the corresponding functions of the cell tracker as defined herein. The cell tracker 94 may be a part of the cell manager 78 or may be a separate device in communication with the cell manager 78. In an exemplary embodiment, the cell tracker 94 may be configured to receive reports from the mobile terminals within a particular cell and track the movement of the cell based on the reports received from the mobile terminals. In other words, the cell tracker 94 may be configured to track movement of the moving cell based on sequential reports received from the members of the group of terminals used to originally define the cell. As such, for example, the cell tracker 94 may be configured to attribute a recently received report received from any one of the members to the group and define a dynamic group characteristic based on the recently received report. In other words, for example, if a cell is defined and one member of the cell reports (e.g., in a most recently received report) a speed of 25 miles-per-hour (mph), the speed attributed to the cell may be 25 mph. As such, the cell may be projected as moving along the road with which the cell is associated at a speed of 25 mph.

In some embodiments, the cell manager may further include other alternative or additional operations such as evaluating each recently received report with respect to correspondence of the recently received report to the dynamic group characteristic currently or previously assigned to the group, and updating group membership based on the evaluation. In other words, for example, in recognition of the fact that each member of the group may have a different destination and thus various members may exit the road associated with the cell (and therefore also exit the corresponding cell), it may be desirable to periodically update group membership. As such, for example, although the movement of the cell is generally defined and projected based on reports received from the members of the group, if one particular member provides a report that differs from the currently projected position, speed, direction and/or other dynamic values or features that may be associated with the cell by a threshold amount (e.g., an incongruous report), the particular member may be dropped from the group. Thus, if the particular member exits the road on an off-ramp and provides (e.g., at its next reporting interval) a corresponding report that is far from the projected position of the cell, the particular member may be released from the group and its reporting rules may be ignored or discarded. The reported information may also be disregarded by the cell tracker 94 with regard to updating cell characteristics. The cell manager 78 may be responsible for managing group memberships in the manner described above.

In an alternative embodiment, if an incongruous report is received, the cell manager 78 may poll one or more other devices to solicit a report outside the normal schedule (or may wait until the next scheduled report is received) in order to compare the next report (or a series of reports) to a prior report that is different from the projected value by the threshold amount. If the next report(s) actually match or follow the trend of the report that was different from the projected value by the threshold amount, the projected value may be updated to correspond to the recent reports. As such, for example, a situation in which traffic has suddenly slowed down or sped up may be detected and accounted for rather than merely resulting in the first member reporting a drastic change in conditions from being excused from the group.

Although initial cell formation may be based on geographic considerations, as indicated above, other factors may also be considered such as direction, speed, etc. This flexibility in cell formation may enable group formation to account for (or perhaps exclude) vehicles that do not correspond to the general traffic flow in a region. For example, vehicles initially close together and perhaps within a region defined as a cell may include a vehicle that is moving either much faster or slower than other vehicles in the cell. Accordingly, such a vehicle would likely be dropped from the group in any case after a relatively few reporting cycles (or even one). Thus, the cell manager 78 may consider the likelihood that a particular mobile terminal or vehicle will not maintain membership in the group based on a characteristic (e.g., a dynamic value such as speed) of the particular mobile terminal. In this regard, for example, defining the group may include defining the group based on speed of mobile terminals selected to be the members being within a threshold value from an average speed of the respective mobile terminals within a particular geographic area corresponding to a cell.

In an exemplary embodiment, the cell manager 78 may be further configured to eliminate the group in its entirety in response to a number of the group members decreasing below a threshold value. In this regard, if group membership decreases by a threshold percentage or reduces to a minimum number, the group may be dropped or eliminated. In such a situation, the cell manager 78 may be configured for defining a new group based on characteristics of devices in a geographical area. In this regard, the projected position of a current cell could be reformed as a new cell with corresponding devices within the cell being associated with a respective group. Alternatively, new members could be added to a cell based on a report received from potential new members indicating that one or more of the potential new members has at least one characteristic (e.g., location, speed, etc.) in common with the other members of the group corresponding to a particular cell. As such, group elimination may be avoided in some instances by dynamically changing group membership. As another alternative, an entirely new cell formation may be formed based on the same “seed cell” definition criteria that were used for original cell formation. In some embodiments, where a particular geographic region (e.g., such as a traffic message channel (TMC) standard cell) is used for initial cell formation, a new snapshot of vehicles in the respective cells may be used to define respective groups of mobile terminals corresponding to each respective seed cell. In some embodiments, the entire service may also be suspended if there is not sufficient participation. For example, if less than a particular percentage of vehicles of the total traffic volume (e.g., 2%) are reporting for the service, the service may be suspended until sufficient numbers are present.

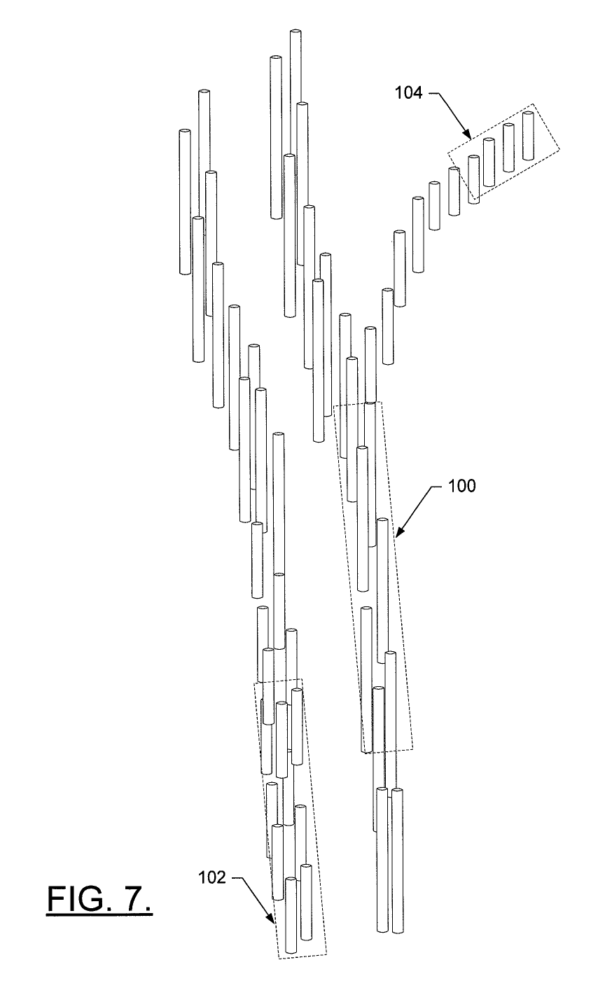

FIG. 7 illustrates an example of a mapping of reports received from mobile terminals within a group according to an exemplary embodiment of the present invention. In this regard, each report of FIG. 7 is indicated as a separate column with the height of each column corresponding to the respective speed of the report (e.g., taller columns correspond to higher speed). FIG. 7 illustrates three separate cells 100, 102 and 104, respectively, although many other groups could also be defined. As shown in FIG. 7, a first cell 100 may correspond to vehicles headed in a first direction at a relatively high speed. Meanwhile, as indicated by the shorter columns, a second cell 102 may correspond to vehicles heading in an opposite direction to that of the first cell 100 and may be doing so at a lower speed. Meanwhile, a third cell 104 may correspond to an off-ramp on which speeds are progressively decreasing.

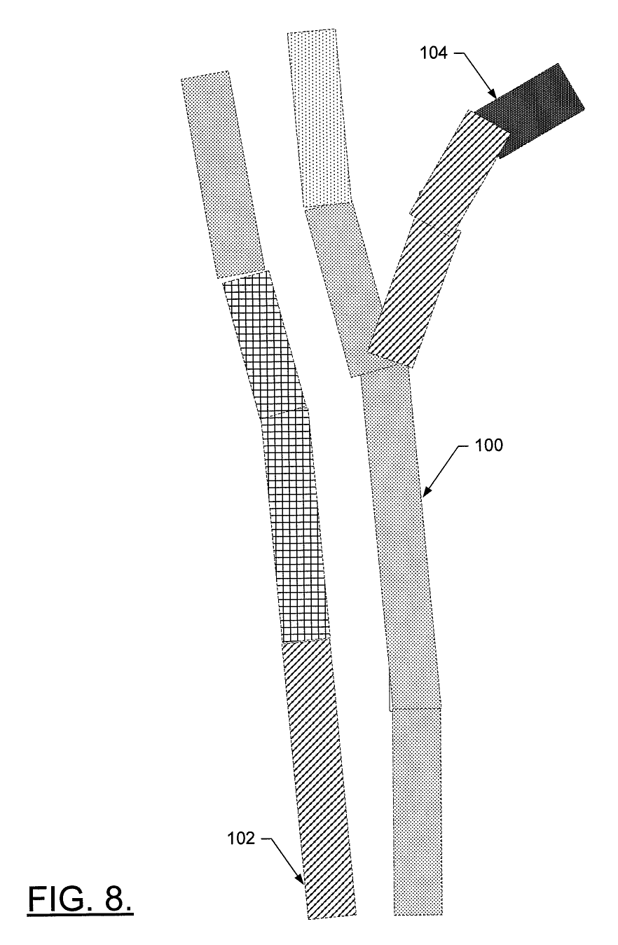

FIG. 8 illustrates an example of a map view providing traffic report information according to an exemplary embodiment of the present invention. In this regard, FIG. 8 illustrates an exemplary view of cells corresponding to the first, second and third cells 100, 102 and 104 of FIG. 7 and other cells corresponding to an entirety of the data displayed in FIG. 7. Each cell may be presented in a manner that is indicative of the average speed of vehicles in the respective cell. For example, each cell may be presented in a corresponding color or shaded with a corresponding scheme that is indicative of the speeds of vehicles in the cell. Furthermore, although FIGS. 7 and 8 show relatively small areas for ease of explanation and demonstration, it should be noted that entire regions and systems of roads may be presented in similar fashion.

Embodiments of the present invention may provide an ability to scale the amount of data communicated for the provision of the service. Additionally, embodiments of the present invention enable robust control over which entities provide reports and when such reports are provided. Accordingly, reduced power consumption for client devices may be achieved in addition to reducing the cost and burden to infrastructure due to a potential reduction in the amount of data transferred thereby providing more efficient bandwidth usage while still providing robust traffic monitoring capabilities. Security could be added to the system by encrypting messages communicated between mobile terminals and network devices.

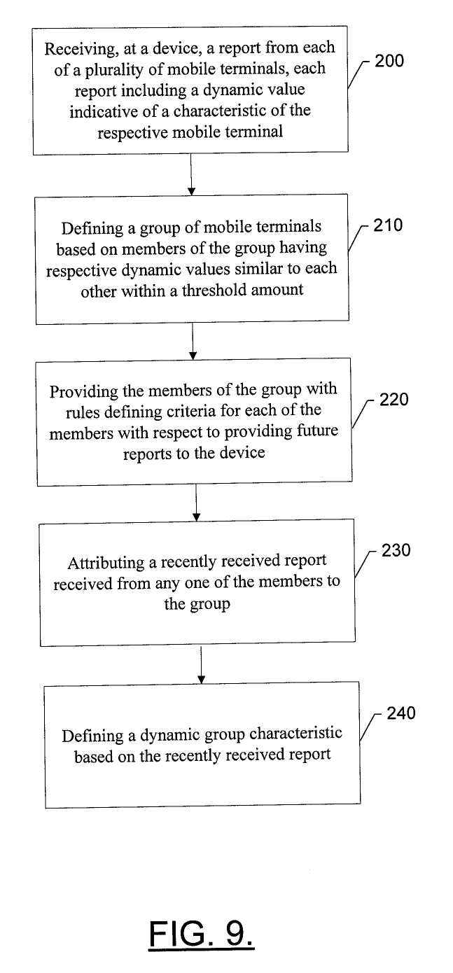

FIG. 9 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or server and executed by a built-in processor in the mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing load balancing for the provision of services to client devices (e.g., mobile terminals) as provided in FIG. 9 may include receiving, at a device (e.g., a server), a report from each of a plurality of mobile terminals, each report including a dynamic value indicative of a characteristic of the respective mobile terminal at operation 200. The method may further include defining a group of mobile terminals based on members of the group having respective dynamic values similar to each other within a threshold amount at operation 210 and providing the members of the group with rules defining criteria for each (or at least some) of the members with respect to providing future reports to the device at operation 220.

In an exemplary embodiment, the method may also include additional optional operations. In this regard, for example, the method may further include attributing a recently received report received from any one of the members to the group at operation 230 and defining a dynamic group characteristic based on the recently received report at operation 240. In some embodiments, defining the group may include defining a moving cell of mobile terminals comprising the members. In such embodiments, the method may further include tracking movement of the moving cell based on sequential reports received from the members.

In an exemplary embodiment, the method may include other alternative or additional operations such as evaluating each recently received report with respect to correspondence of the recently received report to the dynamic group characteristic, and updating group membership based on the evaluating. The method may further include eliminating the group in response to a number of the group members decreasing below a threshold value, and defining a new group based on characteristics of devices in a geographical area corresponding to the location of the group at the time the group is eliminated.

In an exemplary embodiment, defining the group may include defining the group based on initial locations of the respective mobile terminals being within a particular geographic area. In this regard, for example, defining the group may include defining the group based on speed of mobile terminals selected to be the members being within a threshold value from an average speed of the respective mobile terminals within the particular geographic area. In some embodiments, providing the members of the group with rules may include defining a report rotation for members of the group such that only a predetermined fraction of the members provide reports at any given time at which a report is to be received. As such, the method may further include providing each member with a different report schedule defining when the respective member is to provide a report to the device. In some embodiments, providing the members of the group with rules may include defining, for at least one of the members, a condition, the detection of which triggers the at least one member to provide a report to the device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving, at a device, a report from each of a plurality of mobile terminals, each report including a dynamic value indicative of a characteristic of the respective mobile terminal;
defining a group of mobile terminals based on members of the group having respective dynamic values similar to each other within a threshold amount; and
providing the members of the group with rules defining criteria for at least some of the members with respect to providing future reports to the device.

2. The method of claim 1, further comprising:
attributing a recently received report received from any one of the members to the group; and
defining a dynamic group characteristic based on the recently received report.

3. The method of claim 2, wherein defining the group comprises defining a moving cell of mobile terminals comprising the members and wherein the method further comprises tracking movement of the moving cell based on sequential reports received from the members.

4. The method of claim 3, further comprising:
evaluating each recently received report with respect to correspondence of the recently received report to the dynamic group characteristic; and
updating group membership based on the evaluating.

5. The method of claim 4, further comprising:
eliminating the group in response to a number of the group members decreasing below a threshold value; and
defining a new group based on characteristics of devices in a geographical area corresponding to the location of the group at the time the group is eliminated.

6. The method of claim 1, wherein defining the group comprises defining the group based on initial locations of the respective mobile terminals being within a particular geographic area.

7. The method of claim 6, wherein defining the group further comprises defining the group based on speed of mobile terminals selected to be the members being within a threshold value from an average speed of the respective mobile terminals within the particular geographic area.

8. The method of claim 1, wherein providing the members of the group with rules comprises defining a report rotation for members of the group such that only a predetermined fraction of the members provide reports at any given time at which a report is to be received.

9. The method of claim 8, further comprising providing each member with a different report schedule defining when the respective member is to provide a report to the device.

10. The method of claim 1, wherein providing the members of the group with rules comprises defining, for at least one of the members, a condition, the detection of which triggers the at least one member to provide a report to the device.

11. A computer program product comprising at least one computer-readable storage medium having computer-readable program code portions stored therein, the computer-readable program code portions comprising:
a first executable portion for receiving, at a device, a report from each of a plurality of mobile terminals, each report including a dynamic value indicative of a characteristic of the respective mobile terminal;
a second executable portion for defining a group of mobile terminals based on members of the group having respective dynamic values similar to each other within a threshold amount; and
a third executable portion for providing the members of the group with rules defining criteria for at least some of the members with respect to providing future reports to the device.

12. The computer program product of claim 11, further comprising:
a fourth executable portion for attributing a recently received report received from any one of the members to the group; and
a fifth executable portion for defining a dynamic group characteristic based on the recently received report.

13. The computer program product of claim 12, wherein the second executable portion includes instructions for defining a moving cell of mobile terminals comprising the members and wherein the computer program product further comprises a sixth executable portion for tracking movement of the moving cell based on sequential reports received from the members.

14. The computer program product of claim 13, further comprising:
a seventh executable portion for evaluating each recently received report with respect to correspondence of the recently received report to the dynamic group characteristic; and
an eighth executable portion for updating group membership based on the evaluating.

15. The computer program product of claim 14, further comprising:
a ninth executable portion for eliminating the group in response to a number of the group members decreasing below a threshold value; and
a tenth executable portion for defining a new group based on characteristics of devices in a geographical area corresponding to the location of the group at the time the group is eliminated.

16. The computer program product of claim 11, wherein the second executable portion includes instructions for defining the group based on initial locations of the respective mobile terminals being within a particular geographic area.

17. The computer program product of claim 16, wherein the second executable portion includes instructions for defining the group based on speed of mobile terminals selected to be the members being within a threshold value from an average speed of the respective mobile terminals within the particular geographic area.

18. The computer program product of claim 11, wherein the third executable portion includes instructions for defining a report rotation for members of the group such that only a predetermined fraction of the members provide reports at any given time at which a report is to be received.

19. The computer program product of claim 18, further comprising a fourth executable portion for providing each member with a different report schedule defining when the respective member is to provide a report to the device.

20. The computer program product of claim 11, wherein the third executable portion includes instructions for defining, for at least one of the members, a condition, the detection of which triggers the at least one member to provide a report to the device.

21. An apparatus comprising a processing element configured to:
receive, at a device, a report from each of a plurality of mobile terminals, each report including a dynamic value indicative of a characteristic of the respective mobile terminal;
define a group of mobile terminals based on members of the group having respective dynamic values similar to each other within a threshold amount; and
provide the members of the group with rules defining criteria for at least some of the members with respect to providing future reports to the device.

22. The apparatus of claim 21, wherein the processor is further configured to:
attribute a recently received report received from any one of the members to the group; and
define a dynamic group characteristic based on the recently received report.

23. The apparatus of claim 22, wherein the processor is configured to define the group by defining a moving cell of mobile terminals comprising the members and the processor is configured to track movement of the moving cell based on sequential reports received from the members.

24. The apparatus of claim 23, wherein the processor is further configured to:
evaluate each recently received report with respect to correspondence of the recently received report to the dynamic group characteristic; and
update group membership based on the evaluating.

25. The apparatus of claim 24, wherein the processor is further configured to:
eliminate the group in response to a number of the group members decreasing below a threshold value; and
define a new group based on characteristics of devices in a geographical area corresponding to the location of the group at the time the group is eliminated.

26. The apparatus of claim 21, wherein the processor is configured to define the group via defining the group based on initial locations of the respective mobile terminals being within a particular geographic area.

27. The apparatus of claim 26, wherein the processor is configured to define the group by defining the group based on speed of mobile terminals selected to be the members being within a threshold value from an average speed of the respective mobile terminals within the particular geographic area.

28. The apparatus of claim 21, wherein the processor is configured to provide the members of the group with rules via defining a report rotation for members of the group such that only a predetermined fraction of the members provide reports at any given time at which a report is to be received.

29. The apparatus of claim 28, wherein the processor is further configured to provide each member with a different report schedule defining when the respective member is to provide a report to the device.

30. The apparatus of claim 21, wherein the processor is further configured to provide the members of the group with rules via defining, for at least one of the members, a condition, the detection of which triggers the at least one member to provide a report to the device.

31. An apparatus comprising:
means for receiving, at a device, a report from each of a plurality of mobile terminals, each report including a dynamic value indicative of a characteristic of the respective mobile terminal;
means for defining a group of mobile terminals based on members of the group having respective dynamic values similar to each other within a threshold amount; and
means for providing the members of the group with rules defining criteria for at least some of the members with respect to providing future reports to the device.

32. The apparatus of claim 31, further comprising:
means for attributing a recently received report received from any one of the members to the group; and
means for defining a dynamic group characteristic based on the recently received report.
